(19) United States
(12) Patent Application Publication
(10) Pub. No.: US 2009/0246568 A1
(43) Pub. Date: Oct. 1, 2009

(54) SYSTEM FOR THE GENERATION OF ELECTRIC POWER ON-BOARD A MOTOR VEHICLE WHICH IS EQUIPPED WITH A FUEL CELL AND ASSOCIATED METHOD

(75) Inventors: Fabien Boudjemmaa, Puteaux (FR); Emmanuelle Duval-Brunel, Palaiseau (FR); Laurent Fulcheri, Mouans-Sartoux (FR); Nicolas Huon, Paris (FR); Thierry Planas, Maurepas (FR); Jean-Damien Rollier, Cannes (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Renault S.A.S., Boulogne Billancourt (FR)

(21) Appl. No.: 11/721,250

(22) PCT Filed: Dec. 1, 2005
(86) PCT No.: PCT/FR05/51019

§ 371 Date: Jun. 8, 2007

(30) Foreign Application Priority Data
Dec. 8, 2004 (FR) 0413079

(51) Int. Cl. H01M 8/06

(52) U.S. Cl. 429/17; 429/20

(57) ABSTRACT

A system for generation of electric power on-board a motor vehicle of the type that includes a fuel cell, a reformer for supplying the fuel cell with hydrogen-rich gas, an air-compression device, and a control unit used to control the operation of the reformer. The reformer includes a main cold-plasma reformer and an auxiliary cold-plasma reformer that are mounted in parallel upstream of the fuel cell. In addition, a control valve, which is controlled by the control unit, is mounted upstream of the two cold-plasma reformers to supply compressed air, fuel, and water vapor either to the main reformer alone or to both reformers simultaneously.

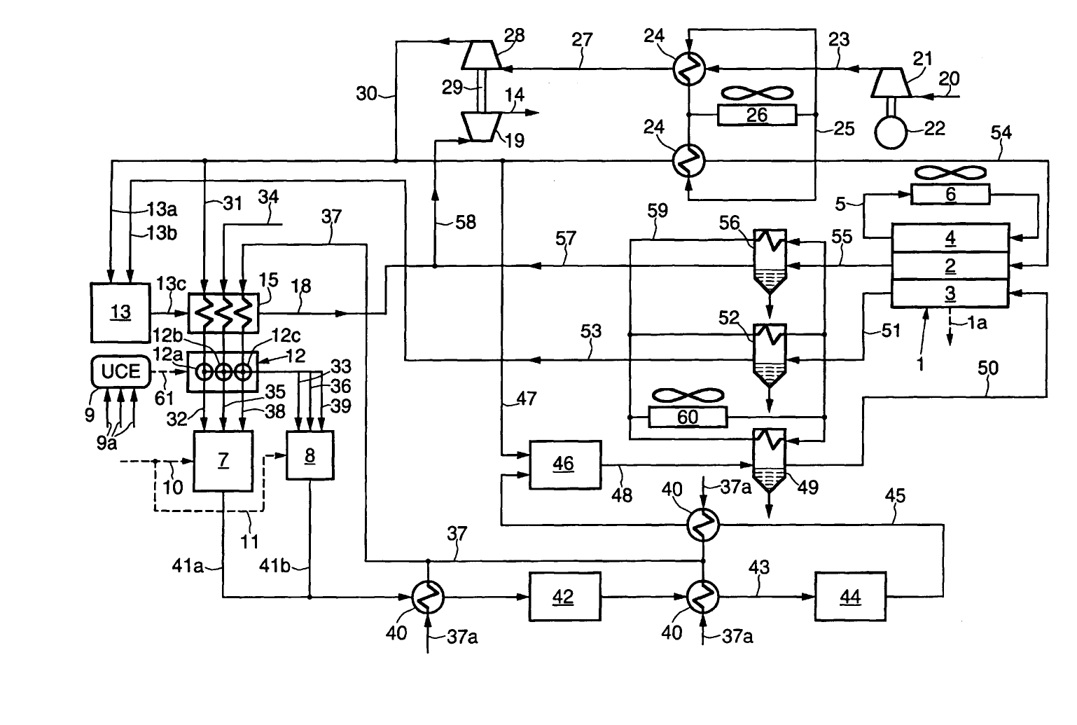

The present invention relates to a system for generating electric power on board a motor vehicle comprising an electric transmission or propulsion line.

Such a hybrid electric power generator generally comprises a fuel cell, a reformer capable of receiving different fuels (gasoline, diesel, ethanol, etc.) associated with a turbocharger and an electric storage battery, the whole being controlled by an electronic control unit. Such an electric power generator can be used to drive a motor vehicle or as an auxiliary power source. In the case of a motor vehicle, such an electric power generator may also be used to supply various electric power consuming devices mounted on the vehicle.

In general, a fuel cell is an electrochemical generator fed with hydrogen-rich gas and with oxygen-rich gas, for example ambient air. Particularly in the automobile industry, use can be made of fuel cells with proton exchange membrane, called PEMFC. Use can also be made of other types of fuel cell, for example, solid oxide fuel cells, called SOFC, the operation of which is simpler. In all cases, the hydrogen-rich gas fed to the fuel cell may be stored on board the vehicle in a tank, thereby limiting the self-contained operating time, due to the sufficiently restricted size of such a tank. The hydrogen-rich gas may also be produced on board the vehicle from a hydrogen-containing fuel using a reformer. This solution serves to obtain comparable self-contained operating time to that of a conventional vehicle and to benefit from the existing fuel distribution network, while reducing the emissions of CO₂ and polluting gases.

The reformers commonly used comprise catalytic reformers and heat exchangers. In a first step, the fuel previously heated by passage through a heat exchanger is catalytically reformed. This is followed by a step of purification of the hydrogen-rich gases formed. This purification serves to decrease the quantity of carbon monoxide present in the gases issuing from the reforming step, to avoid poisoning the fuel cell.

Preferably, the pressure of the air feed to the reformer is increased by using a compressor. Preferably, the reformer is operated in steady state conditions close to the autothermic operating conditions which represent a point of energy equilibrium between steam reforming and partial oxidation. For this purpose, the quantities of fluid conveyed to the inlet of the reformer, that is the hydrocarbon fuel, the oxygen-containing air and the water vapor produced, are appropriately controlled by raising the temperature of the water present in a tank generally mounted on board the vehicle.

The reformate produced by an autothermal catalytic reformer (called ATR) then preferably passes through two purification stages to remove the carbon monoxide, by a water gas reaction, known by the acronym WGS (“Water Gas Shift”), which may comprise two steps, the first at high temperature (HTS) and the second at lower temperature (LTS). The gases then pass through a preferential oxidation stage PrOx, the combination of these steps serving to convert most of the carbon monoxide CO present in the gases produced by the catalytic reformer to carbon dioxide CO₂.

To operate at their highest efficiency, the various components of the reformer must be heated to an optimal operating temperature. For example, in the case of gasoline reforming, the optimal temperature is about 800° C. for the autothermal reformer (ATR), 350° C. for the high temperature water gas reaction step (HTS), 250° C. for the lower temperature reaction step (LTS) and 150° C. for the preferential oxidation step (PrOx).

After purification, the hydrogen-rich gases are conveyed to the fuel cell and partially converted by an electrochemical reaction producing electric power. The hydrogen-rich gases not consumed by the cell, that is, exceeding the stoichiometric reaction ratio, are then used in a catalytic burner to supply the heat required to vaporize the water fed to the reformer and to heat the reagents supplied to the reformer, that is, essentially the fuel and compressed air.

During the cold starting phase, during which it is necessary to heat the various components of the reforming system to their optimal operating temperature, the burner is used to provide the necessary heat to these various components. Owing to the relatively high thermal inertia, it is found that the temperature rise is relatively long and generally takes between 2 and 5 minutes, which raises considerable difficulties in the context of an electric powered motor vehicle. The same applies during a load change resulting for example from a sudden acceleration by the driver of the vehicle.

As an example of a hydrogen generator for supplying electric power to a motor vehicle using a fuel cell, mention can be made of patent application WO-A-00/42671, U.S. Pat. No. 5,335,628, and patent application US-A-2002/4152.

Patent application WO-A-00/31816 describes a reforming system comprising a plurality of different power modules suitable for specific types of operation, for example different vehicle speeds.

French patent application FR-A-2 849 278 (Renault) describes a catalytic reforming system wherein the main components are duplicated.

During cold starting, it is possible to use one of the low power catalytic reforming channels, thereby shortening the starting time. In normal operation, on the contrary, the two catalytic reforming channels are used simultaneously to benefit from maximum power.

Cold plasma or non-thermal plasma reformers are also known, which permit ionization of a hydrogen-containing fuel and thereby replace the catalyst used during catalytic reforming.

Patent application WO-A-98/28223, for example, describes a cold plasma reaction chamber for such reforming.

In U.S. Pat. No. 5,852,927, a hydrogen generator is described comprising a cold plasma reformer supplied with compressed air by a turbocharger.

The use of such cold plasma reformers to supply a fuel cell or to supply an engine with hydrogen-rich gas has already been described, for example in U.S. Pat. Nos. 5,409,784, 4,690,743, and 5,437,250.

In all cases, a cold plasma is produced using one or more exciting electrodes connected to a high voltage electric power source creating electric arcs in the reforming zone.

Such a cold plasma reforming method has the advantage of lowering the reaction temperatures and permitting virtually instantaneous starting of the reforming and the production of hydrogen-rich gas. However, it is found that plasma reformers have the drawback of low efficiency compared with commonly used catalytic reformers.

European patent application EP-A-1 193 218 describes the combined use of a catalytic reformer and a cold plasma reformer. The two reformers can be mounted in parallel and their operation controlled so that the cold plasma reformer is used during a starting phase of the motor vehicle, the catalytic reformer being used during normal operation of the motor vehicle. The plasma reforming reactor is thus activated until the catalytic reforming chamber has reached a suitable temperature. The catalytic reformer is further associated with a burner to vaporize the fuel and the water fed to the device.

The subject of the present invention is a reformer and a method for supplying hydrogen-rich gas to a fuel cell, particularly in a motor vehicle, which permits rapid starting and a response to transient situations of a rapid increase in the load required.

For this purpose, in one embodiment, a system for generating electric power on board a motor vehicle, of the type comprising a fuel cell comprises a reformer for supplying the fuel cell with hydrogen-rich gas, an air compressor, and a control unit for controlling the operation of the reformer. The reformer comprises a main cold plasma reformer and an auxiliary cold plasma reformer mounted in parallel upstream of the fuel cell. A control valve controlled by the control unit is mounted upstream of the two cold plasma reformers to supply compressed air, fuel and water vapor, either to the main reformer alone, or to both reformers simultaneously.

Preferably, the main reformer has a higher nominal capacity than that of the auxiliary reformer.

The nominal capacity of the main reformer may, for example, correspond to 70% to 85%, and preferably 80%, of the maximum total capacity required for the electric power generation system.

Similarly, the nominal capacity of the auxiliary reformer may correspond to 15% to 30%, and preferably 20%, of the maximum total capacity required for the electric power generation system.

In this way, the main reformer can function permanently at its maximum efficiency, while the auxiliary reformer is only activated to provide the extra power required during transient phases corresponding to additional power demands.

The energy efficiency of the overall system is further improved because both reformers always operate at their point of maximum efficiency The service life of the components of the main reformer is also lengthened because this reformer operates permanently, that is, under steady state conditions which are less severe than those resulting from successive starts and stops.

The system may also comprise means for purifying the gases produced by the reformer, by oxidation of the CO produced to CO₂.

Advantageously, the system further comprises a burner supplied with compressed air and with hydrogen-rich gas, not used by the fuel cell, and heat exchange means coupled with the burner to raise the temperature of the fluids fed to the reformer.

Finally, an auxiliary electric storage battery can also be provided. The power requirement of such a battery is, however, very low, thanks to the use of both the abovementioned reformers.

The invention also relates to a method for generating electric power in a motor vehicle equipped with a fuel cell, in which the fuel cell is fed with a hydrogen-rich gas produced by cold plasma reforming, and where two distinct cold plasma reformers are used, the fuel feed to which is controlled, either alternately, or simultaneously, according to the quantity of power required.

Preferably, one of the two reformers is supplied continuously and the other reformer is only supplied during transient phases corresponding to requests for additional electric power.

The invention will be better understood from a study of the detailed description of an embodiment used as an example that is nonlimiting and illustrated by the FIGURE appended hereto, which schematically shows the main components of an electric power generation system mounted on board a motor vehicle and comprising a fuel cell.

As shown in the FIGURE, the electric power generation system comprises a fuel cell numeral 1 as a whole and having a stack of individual cells shown schematically in the FIGURE in the form of a cathode compartment 2 and an anode compartment 3, the whole further being cooled by the flow of a cooling fluid in a cooling zone 4, the cooling circuit 5 comprising a radiator 6 to remove the excess heat. The fuel cell 1 supplies electricity at its output connection 1a.

The anode compartment 3 of the fuel cell 1 may be supplied with hydrogen-rich gas by reforming a hydrocarbon-containing fuel using a main cold plasma reformer 7 and an auxiliary cold plasma reformer 8. The reformers 7 and 8 may comprise, for example, various electrodes supplied with high voltage electric power and capable of generating electric arcs to create a cold plasma. In this respect, reference can be made for example to the prior art mentioned in the introduction

The reformers 7 and 8, shown schematically in the FIGURE, actually comprise a reactor and an electric power supply symbolized by the arrows 10 and 11.

A control valve, numeral 12 as a whole, is mounted upstream of the plasma reformers 7 and 8, in order to control the feed to the two reformers 7 and 8.

The control valve 12 is controlled by an electronic control unit ECU numeral 9 and receiving various data on the operation of the electric power generation system via its inputs 9a.

A heat exchanger 15 is placed upstream of the feed of the two reformers 7 and 8. A burner 13 receives compressed air at an inlet 13a and a hydrogen-rich gas issuing from the anode compartment 3 of the fuel cell 1 and not used by the fuel cell, at its other inlet 13b.

The high temperature combustion gases issuing from the burner 13 are sent, via its outlet 13c, to the heat exchanger 15. The gas stream passing through the heat exchanger 15, to give up its heat, is conveyed via the line 18 to the outlet of the heat exchanger 15, to a turbine 19 which recovers the residual energy from the exhaust gases before their discharge via the exhaust pipe 14.

For the air feed of the reformers 7 and 8, the air issuing from the inlet line 20 undergoes a first compression in a first compression stage 21 driven by a motor 22. The medium pressure compressed air conveyed by the line 23 gives up part of its heat in a regeneration heat exchanger 24 mounted in a cooling circuit 25 which comprises a radiator 26. The compressed air, thereby partially cooled, is conveyed via the line 27, to the inlet of the second compression stage 28 which is part of a turbocharger also comprising the turbine 19 mounted on the same mechanical shaft 29 as the high pressure compressor 28, in order to drive it. The high pressure compressed air issuing from the second compression stage 28 is then conveyed via the lines 30 and 31 to the heat exchanger 15, in order to be heated further therein. At the outlet of the heat exchanger 15, the high temperature compressed air may be conveyed to the main plasma reformer 7 via the line 32 and to the auxiliary plasma reformer 8 via the line 33. The feed is controlled by the control valve 12 which may, for example, comprise three three-way valves, shown schematically by numerals 12a, 12b and 12c.

Liquid fuel contained in a tank mounted on the vehicle, not shown in the FIGURE, is conveyed by the line 34 to the heat exchanger 15 to be vaporized therein. The fuel thus vaporized may be conveyed to the inlet of the main reformer 7 via the line 35 and to the inlet of the auxiliary reformer 8 via the line 36, according to the position of the valve 12b.

Water, issuing from a tank mounted on the vehicle, optionally also containing water produced by the operation of the system itself, is conveyed in liquid form via the line 37 to the inlet of the heat exchanger 15 to be vaporized therein, and then to the inlet of the main reformer 7 via the line 38 and to the inlet of the auxiliary reformer 8 via the line 39. In the example shown, liquid water is conveyed to the heat exchanger 15 via the line 37 after having been supplied via the lines 37a and heated in various heat exchangers 40.

The hydrogen-rich gases produced by the cold plasma reformers 7 and 8 exit via the lines 41a and 41b, and then, after having given up part of their heat to the liquid water passing through the heat exchanger 40, are conveyed to the inlet of the first high temperature water gas reaction stage HTS in a reactor 42. At the outlet of the reactor 42, the hydrogen-rich gases, partly purified, pass through a second heat exchanger 40 to heat the feed water, and are then conveyed via the line 43 to a second lower temperature water gas reaction purification stage LTS in a reactor numeral 44. After this conversion of the carbon monoxide, the gases issuing from the reactor 44 are conveyed via the line 45 to a preferential oxidation reactor 46 after having passed through a heat exchanger 40 where part of their heat serves to heat the feed water from a line 37a. The preferential oxidation reactor PrOx, numeral 46, also receives compressed air, via the line 47 which is connected via the line 30 to the second compression stage consisting of the compressor 28.

At the outlet of the preferential oxidation reactor 46, the gases are conveyed via the line 48 to a pre-anode condenser 49 where the water they contain is mostly removed. The gases are then conveyed via the line 50 to the inlet of the anode compartment 3 of the fuel cell 1. At the outlet of the anode compartment, the gases conveyed via the line 51 pass through an anode condenser 52 where they are stripped of most of the water they contain before being conveyed by the line 53 to the inlet 13b of the burner 13. The excess hydrogen, which has not been used in the fuel cell, is thereby used for combustion in the burner 13.

The cathode compartment 2 of the fuel cell 1 for its part receives, via the line 54, compressed air issuing from the second compression stage materialized by the compressor 28. At the outlet of the cathode compartment 2 of the fuel cell 1, the combustion gases are conveyed via the line 55 to a cathode condenser 56 where they are stripped of most of the water they contain, and then conveyed via the lines 57 and 58 to the inlet of the turbine 19 before escaping through the exhaust pipe 14.

The various condensers 49, 52 and 56 are all cooled by a cooling circuit 59 comprising a radiator 60, the various condensers being mounted in parallel in the circuit, as shown in the FIGURE appended hereto.

The control unit 9 is capable of controlling the control valve 12 via a connection 61.

A plasma reformer reactor, of the type of reformers 7 and 8 serves to convert the hydrogen-containing compounds to hydrogen. In general, thermal plasmas and cold or unbalanced plasmas are known. According to the present invention, cold plasma reformers are essentially used, having a plurality of electrodes supplied by an electric power source, not shown in the FIGURE. Such plasma reformers have a relatively low energy efficiency, generally lower than 70%. However, the reforming reaction develops nearly instantaneously, so that hydrogen-rich gases can be obtained very rapidly at the outlet. The main reformer 7 has a capacity substantially corresponding to 70% to 85%, preferably 80%, of the total capacity required. It can therefore operate permanently and supply the electric power normally required. The auxiliary reformer 8 for its part has a lower capacity, corresponding for example to 15% to 30%, and preferably 20% of the total capacity required. It is therefore only activated, via the control unit 9, when additional power is required.

As shown in the FIGURE, the reforming system operates as follows.

During a starting phase, only the main plasma reformer 7 is used to supply hydrogen very rapidly to the fuel cell 1. For this purpose, upon starting, the control unit 9 controls the control valve 12 in order to supply the main plasma reformer 7 with compressed air via the line 32, with fuel via the line 35, and with water vapor via the line 38.

The hydrogen produced nearly instantaneously by the plasma reformer 7 is sent to the fuel cell 1 after having been suitably purified by the conversion stages 42, 44 and the preferential oxidation reactor 46.

After the starting phase, and during normal operation of the power generation system, the hydrogen-rich gases are essentially supplied by the main reformer 7 which provides a sufficient flow to cover the electric power needs of the vehicle.

If a need is felt for power exceeding, for example, 80% of the nominal capacity, the control unit 9 acts on the control valve 12 in order to additionally supply the auxiliary plasma reformer 8 with compressed air, fuel and water vapor. Thanks to the very high reaction rate of such a cold plasma reformer, the additional power requirement can be covered immediately.

Thanks to the present invention, the energy efficiency of the overall system is improved because each reformer operates at a point close to its optimal efficiency. Moreover, the main reformer operates permanently under virtually steady state conditions, thereby increasing the service life of its components.

1-8. (canceled)

9. A system for generating electric power on board a motor vehicle, comprising:
a fuel cell;
a reformer for supplying the fuel cell with hydrogen-rich gas;
an air compressor; and
a control unit for controlling operation of the reformer,
wherein the reformer comprises a main cold plasma reformer and an auxiliary cold plasma reformer, mounted in parallel upstream of the fuel cell, a control valve controlled by the control unit being mounted upstream of the two cold plasma reformers to supply compressed air, fuel, and water vapor, either to the main reformer alone, or to both reformers simultaneously.

10. The system as claimed in claim 9, wherein the main reformer has a higher nominal capacity than that of the auxiliary reformer.

11. The system as claimed in claim 10, wherein nominal capacity of the main reformer corresponds to 70% to 85%, or 80%, of maximum total capacity required for the electric power generation system.

12. The system as claimed in claim 10, wherein nominal capacity of the auxiliary reformer corresponds to 15% to 30%, or 20%, of maximum total capacity required for the electric power generation system.

13. The system as claimed in claim 9, further comprising means for purifying gases produced by the reformer, by oxidation of CO produced to CO₂.

14. The system as claimed in claim 9, further comprising a burner supplied with compressed air and with hydrogen-rich gas, not used by the fuel cell, and heat exchange means coupled with the burner to raise the temperature of fluids fed to the reformer.

15. A method for generating electric power in a motor vehicle equipped with a fuel cell, comprising:
feeding the fuel cell with a hydrogen-rich gas produced by cold plasma reforming,
wherein two distinct cold plasma reformers are used, and the fuel feed to both reformers is controlled, either alternately, or simultaneously, according to a quantity of power required.

16. The method as claimed in claim 15, wherein one of the two reformers is supplied continuously and the other reformer is only supplied during transient phases corresponding to requests for additional electric power.
